(19) United States
(12) Patent Application Publication
(10) Pub. No.: US 2020/0294130 A1
(43) Pub. Date: Sep. 17, 2020

(54) LOAN MATCHING SYSTEM AND METHOD

(71) Applicant: Matchingpro Limited, Central (HK)

(72) Inventor: Wing Man WONG, Central (HK)

(21) Appl. No.: 16/818,907

(22) Filed: Mar. 13, 2020

(30) Foreign Application Priority Data
Mar. 14, 2019 (HK) 19120931.1

(51) Int. Cl. G06Q 40/02; G06Q 10/10; G06Q 30/08; G06Q 50/26; G06N 20/00; G06N 5/04; G06F 21/62; G06F 16/951; H04N 1/44

(52) U.S. Cl. CPC G06Q 40/025; G06Q 10/107; G06Q 30/08; G06Q 50/265; H04N 1/4453; G06N 5/04; G06F 21/6245; G06F 16/951; G06N 20/00

(57) ABSTRACT

An automatic matching system for loan/credit operation and preferably for loan operation, comprising a loan/credit document verification and generation unit, an optional loan/credit document privacy data processing unit, an artificial intelligence loan/credit matching unit, and a loan/credit offer and auction unit operatively connected with each other; wherein the loan/credit offer and auction unit is configured to notify each lender of a group of potential lender entities and/or companies of a first loan/credit operation and to transmit a first loan/credit document and/or a verified second loan/credit document, so as to require each lender to provide a loan offer for the first loan/credit operation, and initiate an online first auction based on the loan offer, and generate and update in real time an online offer ranking table according to initial and revised offers of each lender during auction period, and determine at least one top ranked lenders and an ultimate accepted/selected lender to proceed with and complete the first loan/credit operation.

### TECHNICAL FIELD

The present disclosure generally relates to the field of devices and methods for credit document verification and credit processing. More particularly, the present disclosure relates to a system, device and method for automatic document verification and credit processing used for a credit system, so that credit parties enjoy greater operation efficiency and convenience.

### BACKGROUND

An artificial or labor-intensive operation is used in most of the existing lender companies, systems and platforms for document examination and evaluation as well as loan matching, so as to determine a validity of a credit application as well credit-related conditions and details. Therefore, the artificial or labor-intensive operation has relatively high credit costs and a relatively long authorization process, resulting in a lower overall operation efficiency. Therefore, there is a long-term need for a fast device and method for automatic operation of credit document examination and credit processing with a low cost in this field.

### SUMMARY

Therefore, embodiments of the present disclosure preferably seek to mitigate, alleviate or eliminate one or more defects, shortcomings or problems in this field, such as those identified above, individually or in any combination by providing devices and methods according to the appended claims.

In one aspect of the invention, a loan matching system for an automatic credit operation and preferably for a loan operation is disclosed, which comprises a credit document examining and generating unit, an optional credit document private data processing unit, an artificial intelligence loan matching unit, and a credit quotation and auction unit which are operatively connected with each other;

the credit document examining and generating unit being configured to acquire/collect debtor data and document for a first credit operation to generate and examine a first debtor credit document for the first credit operation;
the optional credit document private data processing unit being configured to remove or shield a part of the first debtor credit document related to personal privacy/personal identity and/or add a system watermark/mark to generate a second debtor credit document for the first credit operation;
the artificial intelligence loan matching unit being configured to determine/match a group of potential lender individuals and/or companies comprising plural lenders suitable for the first credit operation based on the first debtor credit document for selection; and
the credit quotation and auction unit being configured to notify each selected lender in the group of potential lender individuals and/or companies of the first credit operation and transmit the first debtor credit document and/or the examined second debtor credit document to request each lender to provide a loan quotation for the first credit operation, initiate a first auction online for the first credit operation based on the loan quotation, generate and update an online quotation priority list in real time according to the initial loan quotation and a revised loan quotation of each lender during the first auction for viewing, and generate a final online quotation priority list and determine at least one lender in top ranking after the first auction, so as to further determine a final accepted/selected lender and transmit the first credit document to the accepted/selected lender to continue and complete the first credit operation.

In another aspect of the invention, a loan matching method for an automatic credit operation and preferably for a loan operation is also disclosed, which comprises the following steps:

acquiring/collecting a first credit document for a first credit operation, which preferably comprises a debtor credit requirement/information and/or credit application data/data and/or additional supporting documents necessary for credit preferably through an electronic manner comprising through the Internet, and preferably through a network platform and/or a mobile platform;
contacting the debtor to confirm the first credit document and examine a validity and an accuracy of the first credit document preferably through an electronic manner and/or an artificial manner comprising real-time information through the Internet and/or telephone voice and preferably through a network platform and/or a mobile platform;
removing or shielding a part of the first credit document related to personal privacy/personal identity of the debtor to generate a second credit document for the first credit operation, and preferably removing through an electronic manner;
analyzing credit requirement/information and/or a credit application of the first credit operation, comprising a lending/loan type, a lending/loan amount and debtor/borrower information, to determine/match a group of potential lender individuals and/or companies comprising plural lenders suitable for the first credit operation, wherein the analyzing and the determining are preferably performed by an artificial intelligence IT system;
contacting the debtor to examine and confirm an authenticity of the first credit operation and/or the second credit document, and removing all data related to the first credit operation and/or the second credit document if the examining and the confirming are failed;
notifying each lender in the group of potential lender individuals and/or companies of the first credit operation and transmitting the examined second credit document to request each lender to provide a loan quotation for the first credit operation, wherein the notifying and the transmitting are preferably performed through an electronic manner, comprising a real-time short message/e-mail/mobile application;
initiating a first auction for the first credit operation, and generating and updating a quotation priority list in real time according to an initial loan quotation and a revised loan quotation of each lender during the first auction for the debtor and the lender to view, wherein the lender preferably reverses the loan quotation for three times or less; and
generating a final quotation priority list and determining at least one and preferably at least two lenders in to rank after the first auction, so that the debtor selects an accepted/selected lender from the at least one and preferably at least two lenders in the top ranking, and transmits the first credit document to the accepted/selected lender to enable the debtor and the lender to continue and complete the first credit operation.

According to one embodiment of the invention, the credit document examining and generating unit is configured to acquire/collect the debtor data and document through an electronic manner comprising through the Internet, and preferably through a network platform and/or a mobile platform.

According to another embodiment of the invention, the debtor data and document comprise a debtor credit requirement/information and/or credit application data/data and/or additional supporting documents necessary for credit, and preferably comprise a debtor personal identity card/identity document, a passport, a working/employment permit, an address proof, a payroll, a tax bill, a financial statement, a mortgage payment schedule and a credit report.

According to another embodiment of the invention, the credit document examining and generating unit is configured to contact the debtor to confirm the first credit document and/or the second credit document and examine a validity and an accuracy of the first credit document and/or the second credit document preferably through an electronic manner and/or an artificial manner comprising real-time information through the Internet and/or telephone voice and preferably through a network platform and/or a mobile platform.

According to another embodiment of the invention, the credit document private data processing unit is configured to automatically scan a document content and identify a document type through an electronic manner so as to position and remove or shield the part related to personal privacy/personal identity.

According to another embodiment of the invention, the artificial intelligence loan matching unit is configured to analyze based on a credit requirement/information and/or a credit application of the first credit operation, comprising a lending/loan type, a lending/loan amount, and a debtor/borrower message, to determine/match plural lenders suitable for the first credit operation stored in an internal database of the system, and the analyzing and the determining are preferably performed by an artificial intelligence information system.

According to another embodiment of the invention, wherein the credit quotation and auction unit is configured to notify the first credit operation and transmit the first debtor credit document and/or the examined second debtor credit document through an electronic manner, comprising a real-time short message/e-mail/mobile application.

According to another embodiment of the invention, the credit quotation and auction unit is configured to generate and update the quotation priority list in real time according to the initial loan quotation and the revised loan quotation of each lender during the first auction.

According to yet another embodiment of the invention, the credit quotation and auction unit is configured to allow reversing the loan quotation for a predetermined threshold number of times or less only, and preferably allow reversing the loan quotation for three times or less.

In this way, the credit processing device, system and method of the present disclosure can keep identities of all debtors/accommodators confidential, and preferably use artificial intelligence (using data such as loan types, loan habits of financial institutions, property valuation, etc.) to match appropriate debtors/accommodators with appropriate lenders/loan financial institutions; and/or, enable appropriate lenders/loan financial institutions to carry out real-time bidding via Internet (e.g., via websites, cell phones, PC programs, etc.); and verify the debtor/accommodator data through special personnel or private installations or means, making the whole process and bidding transparent and open, and preferably does not charge any fees from the debtors/accommodators.

The credit processing device, system and method according to the present disclosure enables the debtors/accommodators to apply for loans through the Internet, and can find bidding from a plurality of appropriate lenders/loan financial institutions in a short time, so that the most appropriate loan conditions can be selected quickly and easily. On the other hand, the credit processing device, system and method according to the present disclosure can also help the lenders/financial institutions to expand customers at low prices, omit or not need intermediary work, so that credit processing is fast and time-saving, and the process is fair, open and transparent. Preferably, the debtors/accommodator are provided with personal private data protection and free services, so that the lending parties can benefit from the fast credit processing device, system and method of the present disclosure that can work automatically with a low cost.

### BRIEF DESCRIPTION OF THE DRAWINGS

These and other aspects, features and advantages that can be achieved by the embodiments of the present disclosure will become clear and apparent from the following description of the embodiments of the present disclosure with reference to the accompanying drawings, wherein:

FIG. 1 is a schematic block diagram of an embodiment of an example loan operation or a system for matching both lending parties according to the present disclosure;

FIG. 1A is a schematic flow chart of the embodiment of the example loan operation or a system for matching both lending parties according to the present disclosure;

FIG. 2 is a schematic flow chart of an embodiment of an artificial intelligence loan matching operation/unit of the example loan operation or the system for matching both lending parties according to the present disclosure; and

FIGS. 3a-3d are schematic diagrams of commonly used supporting documents of an example loan operation or a system for matching both lending parties according to the present disclosure respectively.

### DETAILED DESCRIPTION

Specific embodiments of the present invention will now be described in detail in accordance with the accompanying drawings. However, the present disclosure can be embodied in many forms and should not be construed as being limited to the embodiments set forth herein; rather, these embodiments are provided so that contents of the present disclosure will be thorough and complete, and the scope of the disclosure will be fully conveyed to those skilled in the art. The terminologies used in the detailed description of the embodiments shown in the accompanying drawings are not intended to limit the present disclosure. In the accompanying drawings, similar and same reference symbols represent similar and same parts.

It should be emphasized that when the term “comprises/contain” is used in this specification, it is used to define the presence of the stated feature, entirety, steps or components, but does not preclude the presence or addition of one or more other features, entirety, steps, components or combinations thereof.

The present disclosure generally provides a technology as well as a special system and device for matching by using loan application information, debtor/borrower and lender/loan financial institution information, and preferably provides a technology for shielding or deleting borrower identity and contact information in a document submitted by the debtor/borrower; and/or an auction system for promoting credit operation terms or business for the benefits of both lending parties.

According to some embodiments of the present disclosure, the debtor/borrower registers in the system using a mobile phone number thereof, wherein a SMS may be used to verify an identity of the borrower. The borrower may preferably submit a credit/loan application to the system via the Internet (network/mobile platform) and upload supporting documents when necessary to facilitate a further operation. The system calls the borrower to confirm the information thereof and check a validity and an accuracy thereof through an administrator or a staff member; and analyzes the credit/loan application information (such as loan type, loan amount, borrower information, etc.) through an AI (Artificial Intelligence) IT subsystem/unit to match a group of potential lender companies. Preferably, all the documents submitted by the borrower are to be processed so as to shield or delete (if any) identity-related data of the borrower (e.g., name, identity card number, contact information, etc.) After the processed documents are confirmed by the borrower, the system enables the potential lender companies to obtain and use the processed documents, wherein a notification can be sent to matched lenders/lender companies through a real-time short message/e-mail/mobile application to formally launch a new loan application operation. Preferably, the system starts the auction operation through an auction subsystem/unit, wherein all the matched lender companies may access the loan application information and provide new or revised quotations to adjust auction ranking thereof at the beginning of the auction. During the auction, the borrower may view the latest auction situation and auction ranking of the related loan application thereof at any time, and after the auction, the borrower may select at least one lender in the top auction ranking to confirm and complete the credit application and operation.

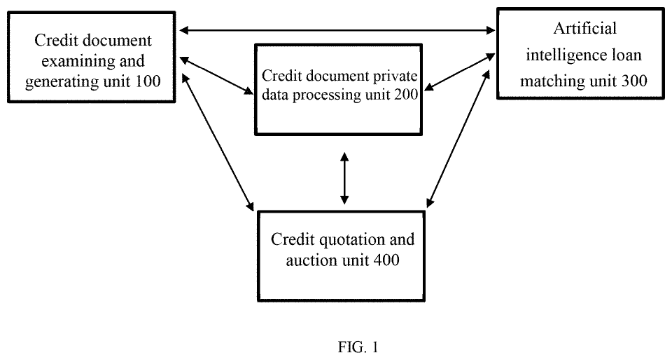

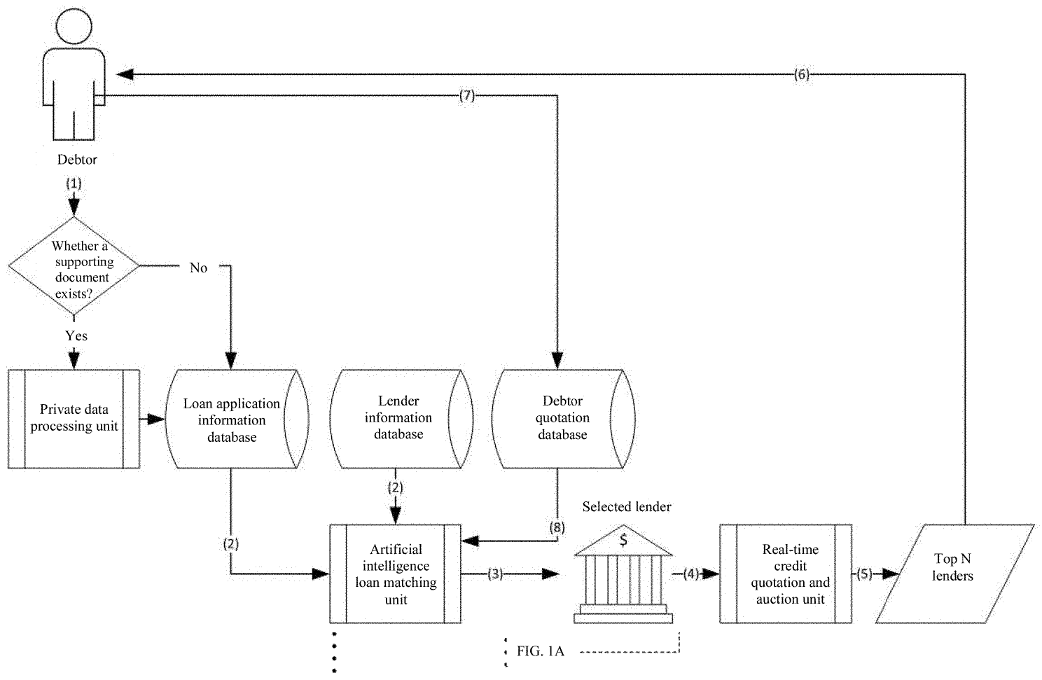

Refer to FIG. 1A, which shows a schematic flow chart of an embodiment of an example loan operation or a system for matching both lending parties according to the present disclosure. The present disclosure discloses a loan matching system for an automatic credit operation and preferably for a loan operation, including a credit document examining and generating unit 100, an optional credit document private data processing unit 200, an artificial intelligence loan matching unit 300, and a credit quotation and auction unit 400 which are operatively connected with each other.

According to the embodiment of the present disclosure, the optional credit document private data processing unit 100 may be configured to acquire/collect debtor data and document for a first credit operation in an online and/or offline manner through an electronic and/or artificial means to generate and examine a first debtor credit document for the first credit operation. When the data and document are collected through the artificial means, the system converts the data and documents into electronic documents to facilitate subsequent automatic operations.

According to some embodiments of the present disclosure, the optional credit document private data processing unit 200 may be included, and may be configured to remove or shield a part of the first debtor credit document related to personal privacy/personal identity and/or add a system watermark/mark to generate a second debtor credit document for the first credit operation. Preferably, a certain or specific stage operation is completed through a fully automated electronic manner or may be completed by using an artificial operation partially, so as to facilitate processing of the first debtor credit document and conversion/generation of the second credit document and further ensure the accuracy of the related operation.

According to the embodiment of the present disclosure, the artificial intelligence loan matching unit 300 may be configured to determine/match a group of potential lender individuals and/or companies including plural lenders suitable for the first credit operation based on the first debtor credit document for selection. With the consent of the debtor, only a single potential lender recommended by the system based on calculations, past records and/or available databases may be provided.

According to the embodiment of the present disclosure, the credit quotation and auction unit 400 may be configured to sequentially or simultaneously notify each lender in the group of potential lender individuals and/or companies in parallel of the first credit operation and transmit the first debtor credit document and/or the examined second debtor credit document according to a database of the system to request each lender to provide a loan quotation for the first credit operation, initiate a first auction online for the first credit operation based on the loan quotation, generate and update an online quotation priority list in real time according to the initial loan quotation and a revised loan quotation of each lender during the first auction for each predetermined party (e.g., debtor and lender in top ranking) to view, and generate a final online quotation priority list and determine at least one lender and preferably at least two lenders in top ranking after the first auction, so as to further determine a final accepted/selected lender (e.g., let the debtor selects from the at least two lenders in the top ranking or other preferred lenders in a specific order at the options thereof) and transmit the first credit document to the accepted/selected lender to continue and complete the first credit operation.

Moreover, another aspect of the present disclosure discloses a loan matching method for an automatic credit operation and preferably for a loan operation, including:

acquiring/collecting a first credit document for a first credit operation, which preferably includes a debtor credit requirement/information and/or credit application data/data and/or additional supporting documents necessary for credit preferably through an electronic manner including through the Internet, and preferably through a network platform and/or a mobile platform;
contacting the debtor to confirm the first credit document and examine a validity and an accuracy of the first credit document preferably through an electronic manner and/or an artificial manner including real-time information through the Internet and/or telephone voice and preferably through a network platform and/or a mobile platform;
preferably, processing (e.g., removing or shielding) a part of the first credit document related to personal privacy/personal identity of the debtor to generate a processed second credit document for the first credit operation, wherein the removing or shielding is automatically performed through an electronic manner preferably;
analyzing credit requirement/information and/or a credit application of the first credit operation, including a lending/loan type, a lending/loan amount and debtor/borrower information, to determine/match a group of potential lender individuals and/or companies including plural lenders suitable for the first credit operation, wherein the analyzing and the determining are preferably performed by an artificial intelligence IT system;
contacting the debtor to examine and confirm an authenticity of the first credit operation, the first credit document and the second credit document based on the first credit document, and removing all data related to the first credit operation, the first credit document and/or the second credit document and not continuing the first credit operation if the examining and the confirming are failed; wherein, the borrower may be notified of errors and requested to resubmit any or all of the correct or required relevant data to maintain a validity of the first credit operation and a feasibility for further processing preferably;
notifying each lender in the group of potential lender individuals and/or companies of the first credit operation and transmitting the examined second credit document to request each lender to provide a loan quotation for the first credit operation, wherein the notifying and the transmitting are preferably performed through an electronic manner, including a real-time short message/e-mail/mobile application;
initiating a first auction for the first credit operation, and generating and updating a quotation priority list in real time according to an initial loan quotation and a revised loan quotation of each lender during the first auction for the debtor and the lender to view, wherein the lender preferably reverses the loan quotation for three times or less; and
generating a final quotation priority list and determining at least one and preferably at least two lenders in to rank after the first auction, so that the debtor selects an accepted/selected lender from the at least one and preferably at least two lenders in the top ranking, and transmits the first credit document to the accepted/selected lender to enable the debtor and the lender to continue and complete the first credit operation.

In some embodiments, the credit document examining and generating unit is configured to acquire/collect the debtor data and document through an electronic manner including through the Internet, and preferably through a network platform and/or a mobile platform.

In some other embodiments, the debtor data and document include a debtor credit requirement/message and/or credit application data/data and/or additional supporting documents necessary for credit, and preferably include a debtor personal identity card/identity document, a passport, a working/employment permit, an address proof, a payroll, a tax bill, a financial statement, a mortgage payment schedule, a credit report, and/or other specific information and/or document conducive to the completion of the loan operation, such as recommender and/or guarantor information, etc.

In some examples, the credit document examining and generating unit is configured to contact the debtor to confirm the first credit document and/or the second credit document and examine a validity and an accuracy of the first credit document and/or the second credit document preferably through an electronic manner and/or an artificial manner including real-time information through the Internet and/or telephone voice and preferably through a network platform and/or a mobile platform.

In some other examples, the credit document private data processing unit is configured to automatically scan a document content and identify a document type through an electronic manner so as to position and remove or shield the part related to personal privacy/personal identity.

In some other examples, the artificial intelligence loan matching unit is configured to analyze based on a credit requirement/information and/or a credit application of the first credit operation, including a lending/loan type, a lending/loan amount, and a debtor/borrower message, to determine/match plural lenders suitable for the first credit operation stored in an internal database of the system, and the analyzing and the determining are preferably performed by an artificial intelligence information system.

In some examples, the credit quotation and auction unit is configured to notify the first credit operation and transmit the first debtor credit document and/or the examined second debtor credit document through an electronic manner, including a real-time short message/e-mail/mobile application.

In some other examples, the credit quotation and auction unit is configured to generate and update the quotation priority list in real time according to the initial loan quotation and the revised loan quotation of each lender during the first auction.

In some other examples, the credit quotation and auction unit is configured to allow reversing the loan quotation for a predetermined threshold number of times or less only, and preferably allow reversing the loan quotation for three times or less.

Refer to FIG. 1A, which shows a schematic flow chart of an embodiment of an example loan operation or a system for matching both lending parties according to the present disclosure, wherein a method for matching both lending parties for an automatic credit operation and preferably for a loan operation is illustrated, including the following steps.

In step (1): debtors/borrowers submit credit/loan applications through different means/channels (e.g., websites, mobile applications, etc.) and provide relevant supporting documents when necessary, including electronic documents and/or paper documents, etc.; The electronic documents may have various formats to facilitate automatic operation, including hundreds or almost all of commonly used document/file formats nowadays, preferably more than 100 commonly used document formats, raster formats and vector formats (such as TXT, RTF, DOC/DOCX, PDF, GIF, JPEG, TIFF, SVG, etc.).

In step (2): the information submitted by all the borrowers is to be stored in a “Loan Application Information Database”. Before entering the database, all the documents are to be first processed by a “private data processing unit” preferably. The privacy preserving data processing unit may automatically add watermarks to all pages of the submitted documents and delete or shield sensitive debtor information (e.g., including but not limited to identity information and contact information). Details of the private data processing unit will be described in detail hereinafter.

In step (3): After all the loan application information and documents are ready for further processing, an “artificial intelligence loan matching unit” retrieves information from the “loan application information database” and a “lender information database”. Then, the artificial intelligence loan matching unit generates or selects a list of lenders/accommodators that best match the needs of the borrowers, and sends a short message/e-mail/mobile phone application to each lender in the list of accommodators to inform the lenders that new loan applications are ready and that the lenders are eligible to provide quotations for the new loan applications for auction/bidding. The borrowers also know when the auction will start and the auction progress through the SMS/e-mail/mobile application. Details of the artificial intelligence loan matching unit will be described in detail hereinafter.

In step (4): the selected lender may access a “real-time credit quotation and auction unit” through the Internet to acquire the loan application information and provide quotation to the loan application. The ranking of quotations will be calculated in real time, and the lender may view and then change the quotation conditions at least once to improve the ranking thereof. Preferably, the quotations are allowed to be changed for at most three times (configurable) to prevent misuse of a change function to guess the highest quotation at current. Details of the credit quotation and auction unit will be described in detail hereinafter.

In step (5): after the auction is ended, scores and ranking of the top N quotations are calculated.

In step (6): the borrowers are notified of the top N loan quotations through a short message/email/mobile application.

In step (7): the borrower may confirm the quotation that is wanted or selected by the borrower, and these information may be stored in a “debtor quotation database”. Then, a relevant administrator/staff member will contact the borrower and the lender providing the quotation that is wanted or selected by the borrower, and help the borrower and the lender complete the loan application process.

In step (8): the “debtor quotation database” is periodically accessed by the “artificial intelligence loan matching unit” to improve a matching accuracy thereof.

In some embodiments, the private data processing unit according to the present disclosure is a software module or a hardware unit that can automatically add watermarks and delete or shield sensitive debtor information in in all pages of the submitted document, and can support, process/read and write, and convert hundreds of document/file formats, preferably more than 100 commonly used document formats, raster formats and vector formats. Preferably, left and right margins of the watermark may be about 5% of a width of the page, a width-to-height ratio of the watermark may be about 1:4, a minimum number of watermarks per page may be 1, a border width of the watermark may be about 0.1, the watermark can rotate and an opacity of the watermark may be about 20. The watermark may contain words “limited to XXXX” and the like to identify a use purpose and to track loan applications and lender information. All the watermark parameters above are configurable and may be changed according to specific situations or applications.

In some embodiments, the private data processing unit defines, generates and/or processes at least one image configuration document. The image configuration document includes specific image modes and features, and is used to define/correspond to supporting documents/files in specific formats, such as a Hong Kong Identity Card, a passport, an address proof, a payroll, a tax bill, a financial statement, a mortgage payment schedule/timetable and a credit report, etc. The image configuration document further defines a location/range of the sensitive debtor data on the supporting document, thereby ensuring that the original sensitive debtor data on the supporting document will not be improperly leaked to unauthorized persons, so that only the lenders approved and agreed by the debtor can access the sensitive debtor data at an appropriate time, thus improving a confidentiality of the system and a trustworthiness of the debtor/lender on the system.

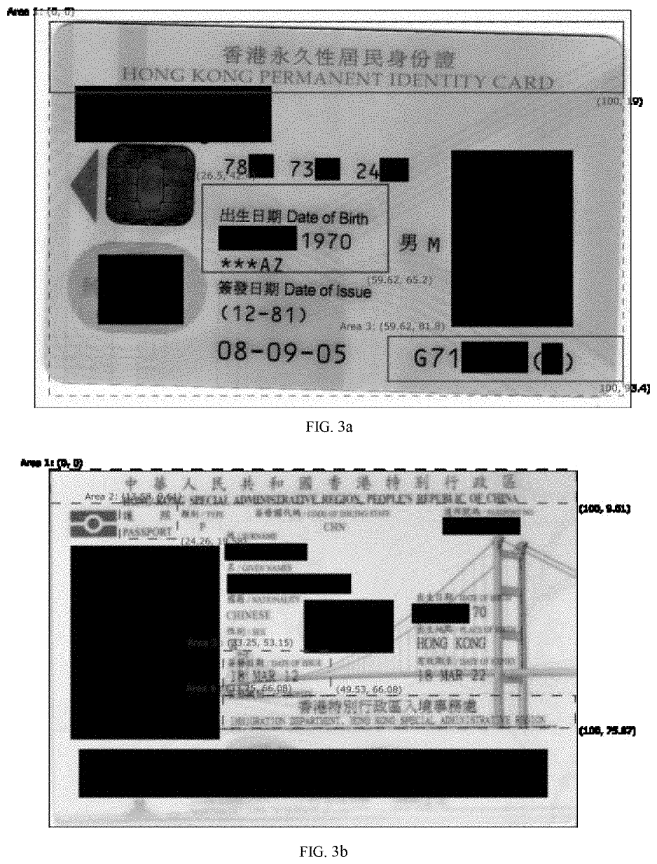

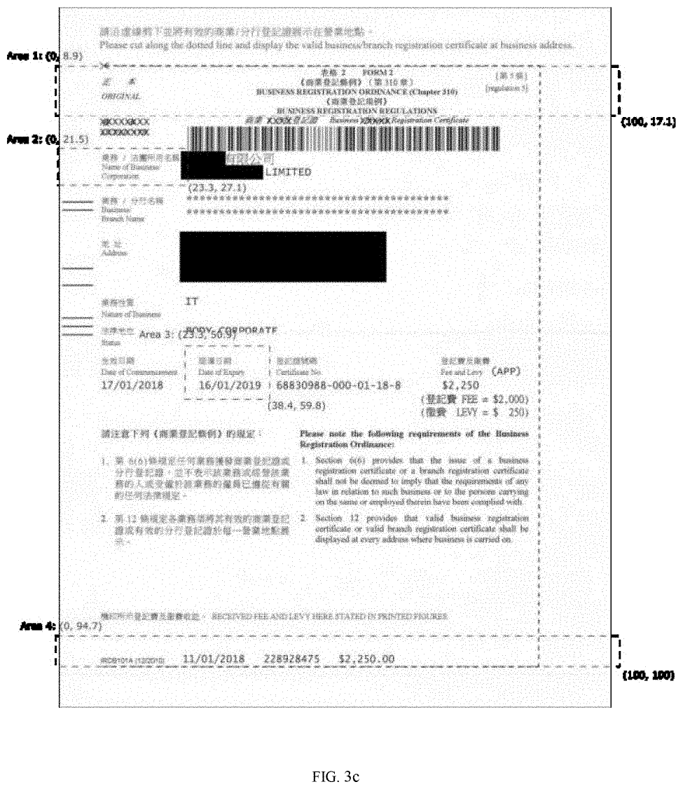

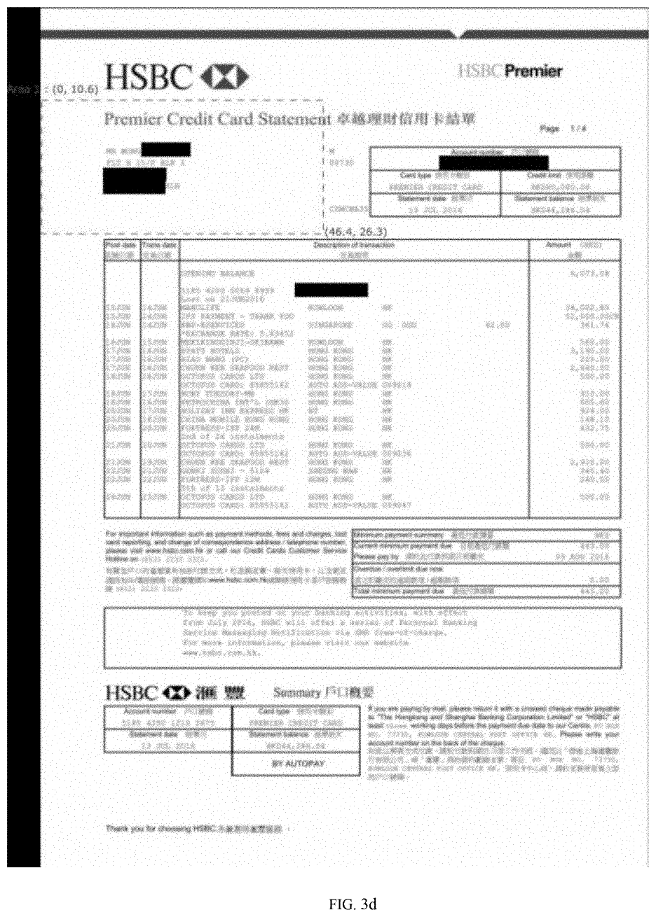

For example, the Hong Kong Identity Card (HKID) image configuration document as shown in FIG. 3a includes the following modes and features:
including keywords “HONG KONG PERMANENT IDENTITY CARD”;
including keywords “Date of Birth”; and
including a set of numbers passing or conforming to a HKID examination logic.

Moreover, the image configuration document also includes the following sensitive data and corresponding positions thereof:
name;
Hong Kong Identity Card No.; and
photo.

According to the present disclosure, as shown in FIG. 3a, an identification of the Hong Kong Identity Card is defined as follows:

| Area | Position | | |
|---|---|---|---|
| name | coordinates | Feature/mode | Probability |
| Area 1 | (0,0)(100,19) | Including words: HONG | 100 |
| | | KONG PERMANENT | |
| | | IDENTITY CARD | |
| Area 2 | (26.5,42.4) | Including words: Date of Birth | 30 |
| | (59.62,65.2) | | |
| Area 3 | (59.62,81.8) | Including a set of numbers | 80 |
| | (100,93.4) | passing or conforming to a | |
| Area 4 | | HKID examinagtion logic | |

As shown in FIG. 3b, an identification of the Hong Kong Passport is defined as follows:

| Area | Position | | Prob- |
|---|---|---|---|
| name | coordinates | Feature/mode | ability |
| Area 1 | (0,0)(100,9.61) | Including words: | 30 |
| | | HONGKONGSPECIAL | |
| | | ADMINISTRATIVEREGIONPEOPLE's | |
| | | [symbol] | |
| Area 2 | (13.58,9.61) | Including words: passport | 50 |
| | (24.26, 19.58) | | |
| Area 3 | (33.25,53.15) | Including words: DATEOFISSUE | 30 |
| | (49.53,66.08) | | |
| Area 4 | (33.25,66.08) | Including words: | 50 |
| | (100, 75.87) | IMMIGRATION [symbol] | |
| | | DEPARTMENT, | |
| | | HONGKONGSPECIAL | |
| | | ADMINISTRATIVEREGION | |

[symbol]

indicates data missing or illegible when filed

As shown in FIG. 3c, an identification of the Hong Kong Business Registration Certificate is defined as follows:

| Area | Position | | Prob- |
|---|---|---|---|
| name | coordinates | Feature/mode | ability |
| Area 1 | (0,8.9)(100,17.1) | Including words: BUSINESS | [symbol] 5 |
| | | REGISTRATION ORDINANCE | |
| Area 2 | (0,21.5)(23.3,27.1) | Including words: Name of | [symbol] 5 |
| | | Business Corporation | |
| Area 3 | (23.3,50.9)(38.4,59.8) | Including words: Date of Expiry | 35 |
| | | and date in DD/MM/YYY format, | |
| | | which is a future date | |
| Area 4 | (0,94.7)(100,100) | Including words: $, indicating | 35 |
| | | that payment has been finished | |

[symbol]

indicates data missing or illegible when filed

As shown in FIG. 3d, an identification of the Address Proof (Bill of HSBC Bank) is defined as follows:

| Area | Position | | Prob- |
|---|---|---|---|
| name | coordinates | Feature/mode | ability |
| Area 1 | (0,10.6) | Including name of the borrower and include | 80 |
| | (46.4,26.3) | more than two of the following words: | |
| | | RM, ROOM, /F, FLOOR, BLK, BLOCK, | |
| | | ROAD, RD, ESTATE, KLN, KOWLOON, | |
| | | HK, HKONG, NONGT, NT, NEW | |
| | | TERRITORRIES, HONG KONG, N.T., | |
| | | NT, [symbol] | |

[symbol]

indicates data missing or illegible when filed

The “address proof” image configuration document is also a common basic image configuration document, and has many sub-image configuration documents derived therefrom. The sub-image configuration documents have the same identification definitions as the basic configuration document thereof, but have different sensitive data areas. The “address proof” image configuration document has the following sub-image configuration documents:
Bill/Statement of HSBC Bank;
Bill/Statement of Hang Seng Bank;
Bill/Statement of Bank of China;
Mortgage Payment Schedule;
Payroll; and
Credit Report.

In some other embodiments, a user may easily add other image configuration documents serving as additional supporting documents/files in the system.

When detecting all the pages in each submitted document, the system uses image recognition software to identify a probability of the page under detection belonging to a specific image configuration document. If the probability is higher than 0.8 (configurable), the image configuration document corresponding to the page under detection is determined and matched. Then, the system uses the image processing software to draw a black rectangle (just like black rectangles in FIGS. 3a-3d) at a location of sensitive data defined in the configuration document to shield or hide/eliminate the sensitive data. The borrower may also view a final processed document/image output upon system request, and may add a rectangle or pattern of a black or specified color at any position requested to shield or hide/eliminate the requested additional part.

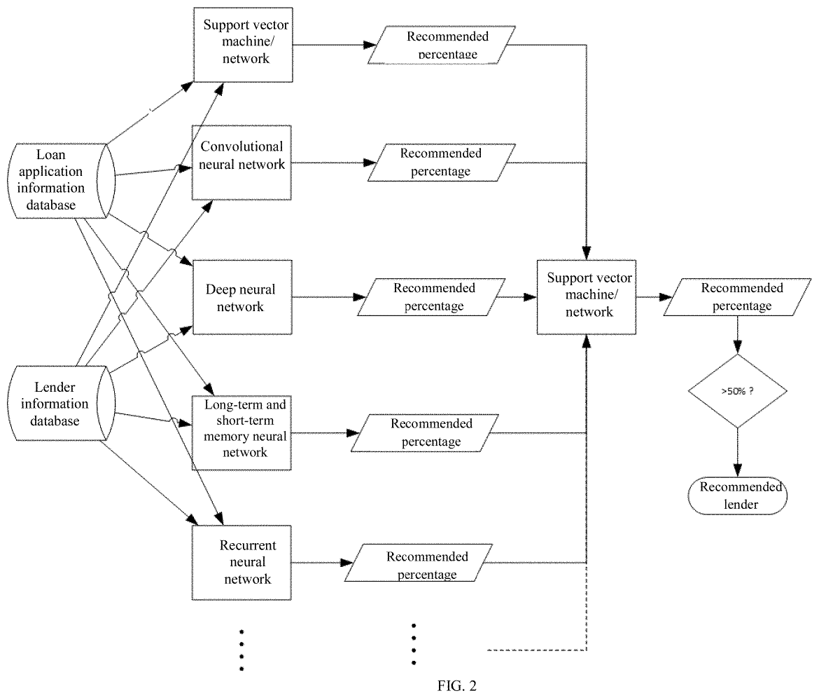

Refer to FIG. 2, which is a schematic flow chart of an embodiment of an artificial intelligence loan matching operation/unit of an example loan operation or a system for matching both lending parties according to the present disclosure. According to the embodiment, an artificial intelligence loan matching unit retrieves information from a “loan application information database” and a “lender information database” and generates a recommended list of lenders/accommodators for a debtor using various AI algorithms (Support Vector Machine (SVM) Machine Learning Model and Deep Learning Neural Network Model such as Deep Neural Network (DNN), Convolutional Neural Network (CNN), and Long-term and Short-term Memory Neural Network (LSTM)).

According to the embodiment of the present disclosure, data in the “loan application information database” and the “lender information database” is deemed as an input layer of an AI model, while an output signal of the model is whether to recommend the lender/accommodator to the debtor/borrower.

At present, the input layer is processed in two stages. In the first stage, the input layer is processed in parallel by five AI models (SVM, CNN, DNN, LSTM and RNN (Cyclic Neural Network)). An output of each AI model is recommendation rate/percentage %, and the 5 outputs serve as input layers of the second stage.

In the second stage, the data is processed by another AI model (SVM). An output of the model is a final lender recommendation rate/percentage %. If the recommendation rate/percentage % is greater than 50%, the lender will be recommended.

In some embodiments, in order to improve an accuracy of AI matching, each AI model needs a continuous machine learning process, and system personnel will automatically generate more than 1M test samples and teach the AI models to learn according to domain knowledge thereof.

True case results are also used as test samples for AI model training. When any debtor/borrower confirms or rejects the quotation of the lender, this information will also be routed/sent as training data.

According to the embodiment of the present disclosure, an AI model selection (machine learning) process includes the followings.

### AI Model Selection in the First Stage

Various AI models are already available in an IT technology market for an AI matching unit/system of the present disclosure to use. In order to select and determine whether these AI models are suitable for use, each AI model is tested and verified according to the following procedures.

1) Each AI model is trained independently by using more than 1M test samples.
2) After training the model, another verification test sample is input into the training model to determine a verification test accuracy.
3) If the verification test accuracy is higher than 80%, the specific AI model is used as one of the AI models in the first stage in the AI matching unit/system.

According to the embodiment of the present disclosure, after the above verification process, five AI models are passed and thus adopted, including: SVM, CNN, DNN, RNN and LSTM. In the future, any new innovative AI model/algorithm will also be verified using the above selection process. If the model can pass the selection criteria, the model can be applied to the AI matching units/system. Therefore, it is expected that more than 5 AI models will be adopted in future AI matching units/systems.

### AI Model Selection in the Second Stage

After all the AI models in the first phase are confirmed, it is ready to select appropriate AI models for the second phase. The following process can be performed to determine the best AI models for the second phase.

1) For each AI model, the AI model is set as an AI model in the second stage.
2) The model is trained by using more than 1M test samples.
3) Then the verification test samples are input into the trained model to determine a verification test accuracy.
4) Steps 1 to 3 are repeated for other AI models.
5) After completing all the above steps, the AI model with the highest verification test accuracy is adopted as the AI model in the second stage.

According to the embodiment of the present disclosure, SVM is used as the AI model in the second stage in the AI matching unit/system after the above selection process.

According to the embodiment of the present disclosure, the following data points in the database will be used as input layers: debtor/borrower information, such as age, income, etc.; loan application information, such as mortgage amount, mortgage type, etc.; and lender/accommodator information, such as capital size, loan preference, pledge type, etc.

According to the present disclosure, after receiving a recommended lender list, a real-time credit quotation and auction unit or a real-time auction system will send a notice to the borrower and the lender and start the auction period, and then the recommended lender will access/visit the auction system to acquire credit/loan application information and provide quotations accordingly, wherein the workflow is as follows.

a) The system automatically sends a notice to the borrower and the recommended lender through a real-time short message/e-mail/mobile application.
b) The lender can access/visit a loan application and borrower information, and a watermark displayed in the document includes a code/number for identifying the lender. The lender/accommodator can only view the information through a screen, but cannot save, export and print the document, so as to protect the privacy of the borrower.
c) The lender can offer preferences in different auction pools, and the auction pools include the following two types:
a first auction pool: the borrower does not need to submit other supporting documents; and
a second auction pool: the borrower needs to submit other supporting documents designated by the lender.

The accommodator can input an approved loan interest rate and a loan size into the auction unit/system for quotation. The accommodator does not need to quote in all auction pools.

d) Then, ranking is performed according to a quotation score. The quotation score is a weighted average of several values, including an offered loan rate, an offered loan size, an application loan size, a lender recommendation %, and a No. of mismatched lender criteria/requirements, etc. A calculation formula of the quotation score is as follows:

Loan_rate_score=(20−offered loan rate)/20

Loan_size_score=(offered loan size/borrower request loan size) Recommendation_score=recommendation % of lender (from the previous AI matching unit/system)

Mismatched_score=(4−No. of mismatched lender requirements)/4

W1=weighting factor of loan rate score=50 (configurable)
W2=weighting factor of loan size score=30 (configurable)
W3=weighting factor of recommendation score=10 (configurable)
W4=weighting factor of mismatched score=10 (configurable)
then, the quotation score=W1*Loan_rate_score+W2*Loan_size_score+W3*Recommendation_score+W4*Mismatched_score
e) Quotation times, viewing times, lender ranking and other auction-related information can be viewed in real time in the auction unit/system.
F) The accommodator can change the quotation thereof for three times at most, so as to prevent misuse of the change to predict the highest quotation.
g) After the auction, the system automatically sends a notice to the borrower through a short message/e-mail/mobile application for further credit operation.

It is obvious that the features and attributes of the specific embodiments disclosed above can be combined in different ways to form additional embodiments, all of which shall fall within the scope of the present disclosure.

Conditional languages used herein, such as “capable”, “can”, “possible”, “may” “e.g.” and the like, are generally meant to convey that certain embodiments include, while other embodiments do not include, certain features, components, and/or states unless explicitly stated otherwise or otherwise understood in the context of use. Thus, such conditional languages are generally not intended to imply that one or more embodiments require the described features, components, and/or states in any case.

The present disclosure has been described above with reference to the specific embodiments. However, other embodiments excluding those above are also possible within the scope of the present disclosure. Different method steps from those described above may be provided within the scope of the present disclosure. Different features and steps of the present disclosure may be combined in other combinations than those described. The scope of the present disclosure is limited by the appended claims only.

1. A loan matching system for an automatic credit operation and preferably for a loan operation, comprising a credit document examining and generating unit, an optional credit document private data processing unit, an artificial intelligence loan matching unit, and a credit quotation and auction unit which are operatively connected with each other;
the credit document examining and generating unit being configured to acquire/collect debtor data and document for a first credit operation to generate and examine a first debtor credit document for the first credit operation;
the optional credit document private data processing unit being configured to remove or shield a part of the first debtor credit document related to personal privacy/personal identity and/or add a system watermark/mark to generate a second debtor credit document for the first credit operation;
the artificial intelligence loan matching unit being configured to determine/match a group of potential lender individuals and/or companies comprising plural lenders suitable for the first credit operation based on the first debtor credit document for selection; and
the credit quotation and auction unit being configured to notify each selected lender in the group of potential lender individuals and/or companies of the first credit operation and transmit the first debtor credit document and/or the examined second debtor credit document to request each lender to provide a loan quotation for the first credit operation, initiate a first auction online for the first credit operation based on the loan quotation, generate and update an online quotation priority list in real time according to the initial loan quotation and a revised loan quotation of each lender during the first auction for viewing, and generate a final online quotation priority list and determine at least one lender in top ranking after the first auction, so as to further determine a final accepted/selected lender and transmit the first credit document to the accepted/selected lender to continue and complete the first credit operation.

2. The system according to claim 1, wherein the credit document examining and generating unit is configured to acquire/collect the debtor data and document through an electronic manner comprising through the Internet, and preferably through a network platform and/or a mobile platform.

3. The system according to claim 1, wherein the debtor data and document comprise a debtor credit requirement/information and/or credit application data/data and/or additional supporting documents necessary for credit, and preferably comprise a debtor personal identity card/identity document, a passport, a working/employment permit, an address proof, a payroll, a tax bill, a financial statement, a mortgage payment schedule and a credit report.

4. The system according to claim 1, wherein the credit document examining and generating unit is configured to contact the debtor to confirm the first credit document and/or the second credit document and examine a validity and an accuracy of the first credit document and/or the second credit document preferably through an electronic manner and/or an artificial manner comprising real-time information through the Internet and/or telephone voice and preferably through a network platform and/or a mobile platform.

5. The system according to claim 1, wherein the credit document private data processing unit is configured to automatically scan a document content and identify a document type through an electronic manner so as to position and remove or shield the part related to personal privacy/personal identity.

6. The system according to claim 1, wherein the artificial intelligence loan matching unit is configured to analyze based on a credit requirement/information and/or a credit application of the first credit operation, comprising a lending/loan type, a lending/loan amount, and a debtor/borrower message, to determine/match plural lenders suitable for the first credit operation stored in an internal database of the system, and the analyzing and the determining are preferably performed by an artificial intelligence information system.

7. The system according to claim 1, wherein the credit quotation and auction unit is configured to notify the first credit operation and transmit the first debtor credit document and/or the examined second debtor credit document through an electronic manner, comprising a real-time short message/e-mail/mobile application.

8. The system according to claim 1, wherein the credit quotation and auction unit is configured to generate and update the quotation priority list in real time according to the initial loan quotation and the revised loan quotation of each lender during the first auction.

9. The system according to claim 1, wherein the credit quotation and auction unit is configured to allow reversing the loan quotation for a predetermined threshold number of times or less only, and preferably allow reversing the loan quotation for three times or less.

10. A loan matching method for an automatic credit operation and preferably for a loan operation, comprising the following steps of:
acquiring/collecting a first credit document for a first credit operation, which preferably comprises a debtor credit requirement/information and/or credit application data/data and/or additional supporting documents necessary for credit preferably through an electronic manner comprising through the Internet, and preferably through a network platform and/or a mobile platform;
contacting the debtor to confirm the first credit document and examine a validity and an accuracy of the first credit document preferably through an electronic manner and/or an artificial manner comprising real-time information through the Internet and/or telephone voice and preferably through a network platform and/or a mobile platform;
removing or shielding a part of the first credit document related to personal privacy/personal identity of the debtor to generate a second credit document for the first credit operation, and preferably removing through an electronic manner;
analyzing credit requirement/information and/or a credit application of the first credit operation, comprising a lending/loan type, a lending/loan amount and debtor/borrower information, to determine/match a group of potential lender individuals and/or companies comprising plural lenders suitable for the first credit operation, wherein the analyzing and the determining are preferably performed by an artificial intelligence IT system;
contacting the debtor to examine and confirm an authenticity of the first credit operation and/or the second credit document, and removing all data related to the first credit operation and/or the second credit document if the examining and the confirming are failed;
notifying each lender in the group of potential lender individuals and/or companies of the first credit operation and transmitting the examined second credit document to request each lender to provide a loan quotation for the first credit operation, wherein the notifying and the transmitting are preferably performed through an electronic manner, comprising a real-time short message/e-mail/mobile application;
initiating a first auction for the first credit operation, and generating and updating a quotation priority list in real time according to an initial loan quotation and a revised loan quotation of each lender during the first auction for the debtor and the lender to view, wherein the lender preferably reverses the loan quotation for three times or less; and
generating a final quotation priority list and determining at least one and preferably at least two lenders in to rank after the first auction, so that the debtor selects an accepted/selected lender from the at least one and preferably at least two lenders in the top ranking, and transmits the first credit document to the accepted/selected lender to enable the debtor and the lender to continue and complete the first credit operation.
